(19) United States
(12) Patent Application Publication
(10) Pub. No.: US 2015/0073639 A1
(43) Pub. Date: Mar. 12, 2015

(54) HYBRID DRIVE TRAIN CONTROL METHOD

(71) Applicants: Monika Alicia Alexandra Minarcin, River Forest, IL (US); Matthew David Hunkler, Fort Wayne, IN (US)

(72) Inventors: Monika Alicia Alexandra Minarcin, River Forest, IL (US); Matthew David Hunkler, Fort Wayne, IN (US)

(73) Assignee: International Engine Intellectual Property Company , LLC, Lisle, IL (US)

(21) Appl. No.: 14/395,220

(22) PCT Filed: Apr. 18, 2012
(86) PCT No.: PCT/US12/33976

§ 371 Date: Oct. 17, 2014

(51) Int. Cl. B60W 20/00; B60W 40/04; B60W 10/18; B60W 40/06; B60W 10/08; B60W 10/06

(52) U.S. Cl. CPC B60W 20/10; B60W 10/08; B60W 10/06; B60W 10/18; B60W 40/06; B60W 40/04; Y10S 903/93
USPC 701/22; 180/65.265; 903/930

(57) ABSTRACT

A control system for a hybrid vehicle utilizes telematics and on board sources to obtain information relating to operating conditions. The data is used to modify hybrid-electric drive train operation to extend the life of components of the drive train. In response to requests for propulsion, data relating to expected conditions of operation including one or more of the following, weather, traffic and road conditions, determines what proportion of the request to meet from the internal combustion engine and what proportion to meet from the electrical motor. The proportion of the request for propulsion allocated to the engine is increased where expected conditions of operation impose excessive stress on electrical components of the drive train.

### BACKGROUND

1. Technical Field

The technical field relates generally to vehicles with a plurality of prime movers and, more particularly, to methods for dynamic allocation of propulsion power demand among the prime movers.

2. Description of the Technical Field

Electrical motors generally exhibit greater operating efficiencies than internal combustion engines. In addition, internal combustion engines achieve their maximum efficiencies over relatively narrow RPM and torque ranges in comparison to electrical motors. Consequently, operational rules programmed into vehicle control systems for vehicles which use both electrical traction motors and internal combustion engines for propulsion generally favor using the electrical motors over the internal combustion engine for propulsion absent certain conditions. Conditions which can affect propulsion demand may include, by way of example, conditions of extreme heat and cold which impair operation of a vehicle's rechargeable energy storage system (RESS), a particular concern where the RESS is constructed from batteries. Vehicles including both internal combustion engines and electric motors for propulsion can include hybrid-electric vehicles with parallel hybrid drive trains, plug in hybrid-electric vehicles (PHEV) and range extended electric vehicles (REEV). The general rule here is that a vehicle's internal combustion engine is usually run only under certain circumstances, typically relating to a low RESS state of charge (SOC) or, if data relating to such is available, RESS state of energy (SOE). On certain types of hybrid-electric vehicles the internal combustion engine may only be run at its maximum efficiency in response to a low battery SOC or SOE.

Rules favoring the use of electrical motors have been constrained by various operational limitations. For example, an RESS may be constructed from a number of different power storage elements, for example batteries and capacitors, and may mix those elements. A given RESS design thus may have a quite limited capacity for storage of usable energy per unit mass when contrast to the hydro-carbon fuels usually used with internal combustion engines. The RESS may also exhibit limitations in terms of the rate at which it can be discharged and recharged. If a hybrid-electric vehicle is in use a large proportion of the time and is called on to operate over distances exceeding the capacity of the RESS to carry the vehicle it is unavoidable that the internal combustion engine will be run.

The use of vehicle telematics technology has become more widespread in recent years. Vehicle telematics offer possibilities for gathering and utilizing information about traffic and other location specific information. Telematics make it possible for a vehicle control system to communicate with the road infrastructure, computers and other vehicles, as well as to obtain GPS location and weather data. Such data have been used to allow drivers to plan routes to avoid traffic congestion and road closures.

### SUMMARY

A vehicle comprises a drive train with at least a first configuration of an electrical motor for available for propulsion and an internal combustion engine available for propulsion, a source of generated electricity and a rechargeable energy storage system. A control system dynamically establishes rules for operating the drive-train. The rule provides for handling requests for propulsion, obtaining data relating to expected conditions of operation including one or more of the following, weather, traffic and road conditions and responsive to requests for propulsion and the obtained data determining what proportion of a request for propulsion to meet from the internal combustion engine and what proportion to meet from the electrical motor. The proportion of the request for propulsion allocated to the internal combustion engine is increased in favor of the internal combustion engine where expected conditions of operation stress electrical components of the drive train beyond at least a first predetermined limit.

### BRIEF DESCRIPTION OF THE DRAWINGS

FIG. 1 is a generalized view of vehicles operating in a telematics enabled environment.

FIG. 2 is a high level block diagram of a control system for a hybrid-electric drive train for a motor vehicle such as one or more of the vehicles of FIG. 1.

### DETAILED DESCRIPTION

In the following detailed description, like reference numerals and characters may be used to designate identical, corresponding, or similar components in differing drawing figures.

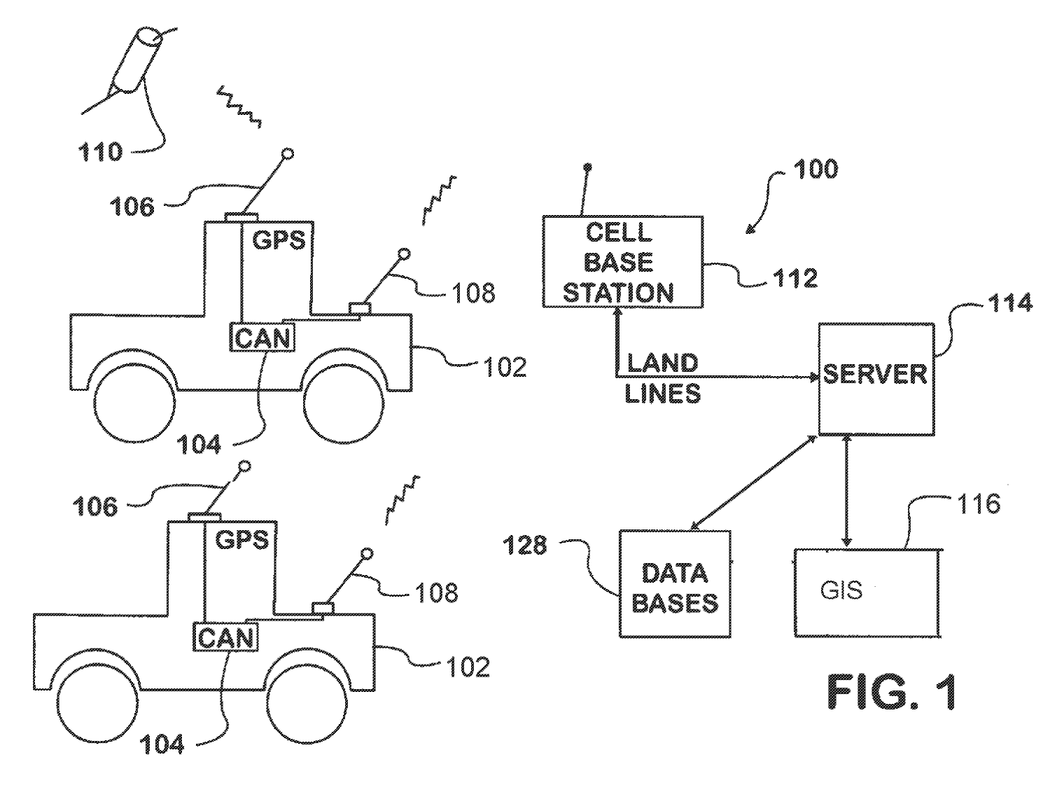

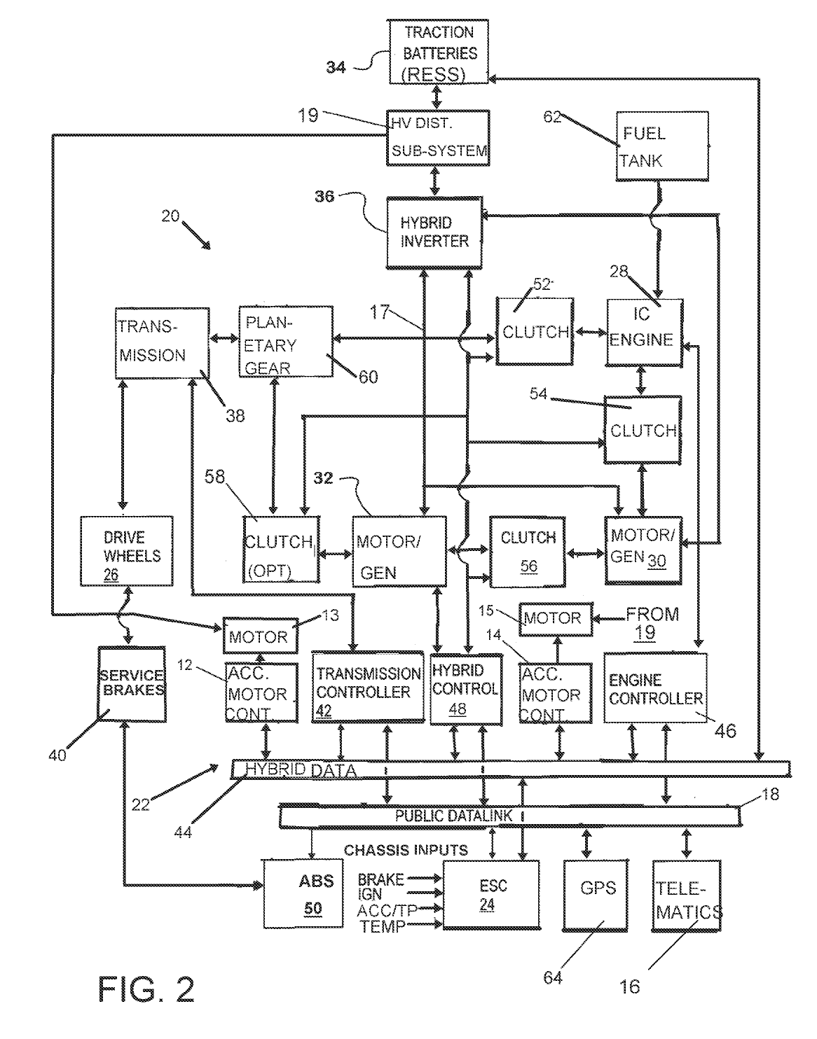

Referring now to the figures and in particular to FIG. 1, a generalized telematics enabled environment 100 is illustrated. Vehicle telematics enabled environment 100 may be implemented for one vehicle 102 or over/between a fleet of vehicles 102. A given vehicle 102 may be supplied with, or be able to calculate and project, expected delays on a road due to traffic, construction, weather, or emergencies. For a vehicle equipped with a hybrid-electric drive train 20 (See FIG. 2) such delays may be projected as likely to result in a high frequency of cycles in charging and discharging of a vehicle Rechargeable Energy Storage System (RESS), and repeated stopping and starting of an internal combustion engine in a compressed time period to recharge the RESS or to supplement demands for propulsion. Such operating demands can result in overheating of electric traction motors or electrical storage batteries where such batteries serve as the RESS (with resultant increases in resistance leading to still greater heat generation) and other issues. Overheating issues can be made worse on account of weather conditions, particularly high heat and humidity levels, with the consequential effects of such conditions on the ability of a vehicle 102 to reject heat and additional demands for power to support refrigeration.

Vehicle 102 includes an electronic control system 22 (See FIG. 2) which may be based on controller area networks (CAN) including a public data link 18. Public data link 18 links numerous controllers on board vehicle 102 for data communication and allows central activation and control of remote data communications services through cellular phone link 108. CAN 18 may include a node which incorporates an antenna 106 for a global positioning system (GPS) unit for determining a vehicle's location from the constellation of GPS satellites 110 or incorporate some other mechanism allowing determination of the location of the vehicle.

Communication between a vehicle 102 and data bases 128 or other vehicles 102 can occur either through road infrastructure sent wirelessly by antenna 108 to the cars around them, via cell towers, or some other means of transmission. Processing of the incoming data could potentially be done in three ways:

1) The processing is done by vehicle itself on the road, and on-board controller makes localized decisions on how to proceed;
2) Processing collections of the data is passed between cars, and then a decision is made and transmitted between the cars; or
3) Processing collections of the data and making a decision is done at another location with operational rules then passed to the vehicles on the road.

By way of illustration, telematics environment 100 includes a cell phone base station 112 which is linked to a server 114 by land lines. Data transmitted from the vehicle 102 can include information specifying the vehicle's location. A vehicle 102 may communicate with a vehicle operations server 114 using any convenient means such as a cellular telephone antenna 108 to link with a cellular base station 112. Cellular base station 112 is linked to server 114 using suitable communication links such as land lines to server 114. In addition, or alternatively, vehicle 102 may communicate directly or indirectly over one or more base stations 112 with other vehicles 102 in a given geographic region. Alternative communication systems, both public and private can readily be used. A geographic region for which an operational rule for a vehicle 102 is generated may be taken as a particular stretch of road at a particular time. Data available to the vehicle electronic control system 22 from server 114 includes a geographic information system (GIS) database. GIS databases can for example specify the location of public roads and speed limits. Co-location on a road by a group of vehicles 102 may be determined from GPS and GIS data. In return server 114 may access private and public data bases 128 and GIS 116 to return real time traffic and weather information, to the extent available.

Vehicle on board traffic visualizations of real time traffic, mostly in the form of geographic maps, have become quite popular. Governments (federal and local) and other organizations supply real time traffic data and pollution information in increasing numbers of locales. It is also possible that vehicle to vehicle data could be used to produce real time traffic data without dedicated data bases. The primary influence of this data to date has been to encourage drivers to re-route themselves. Relatively less has been done to change vehicle operational behavior in response to such data.

Under certain driving conditions, particularly hot climactic conditions, aggressive usage of electric components in a hybrid-electric drive train system may cause de-rating of components in or related to the drive train. Information relating to temperature, humidity, traffic data, and available known route information can allow control system 22 components such as a hybrid controller 48 to make an informed calculation on how to operate the hybrid-electric drive train 20 in order to protect the drive train and related components from premature wear and to maintain safe vehicle operation. For example, the potential for regenerative braking may be limited by ice on roads. Adjusting the engine stop/start algorithm, regenerative braking strategy, and general selection of hybrid operating modes could be implemented to compensate for an expected loss of regenerative braking.

Data relating to likely traffic delays or other impediments/factors such as weather conditions relating to vehicle 102 operation, wherever or however obtained, may be used by the control system 22 to characterize hybrid-electric drive train 20 operating conditions in terms of stress placed on the hybrid-electric drive train. Stress can be quantized as increased cycling frequency of regenerative braking and electric propulsion or current inflows/outflows to the traction batteries 34 using temperature/humidity as a factor. Such stress can potentially contribute to premature failure of hybrid-electric drive train 20 components or a traction batteries 34 serving as the vehicle RESS.

Energy efficiency for a rechargeable traction batteries 34 is usually expressed as a percentage of the electrical energy stored in a battery by charging that is recoverable during discharging. For an electrolytic cell this is the fraction, usually expressed as a percentage, calculated as the theoretically required energy divided by the energy actually consumed in the process (production of a chemical, electroplating, etc). The inefficiencies arise from current inefficiencies and the inevitable heat losses due to polarization.

As most devices (for example, motors, inverters, or the like) that may be coupled to the RESS are characterized and controlled on the basis of the power they consume or generate, the energy flow through them is defined by the integral of power with respect to time (energy=power×time). The commonly reported RESS variable, SOC, represents a percentage of the total capacity of the RESS, is inconsistent with the reckoning of energy flow through the other devices in the system.

Returning to conditions which may affect traction batteries 34 temperature levels may be considered. The condition of batteries 34 may deteriorate more quickly at high temperatures than otherwise if current in flow is not limited. Current outflow from the battery may be aggravated by air conditioning and other refrigeration demands because cooling systems on hybrid-electric vehicles often rely on accessory electric motors 68, 70 to run compressors and coolant circulation pumps. Under conditions of extreme cold batteries 34 may be unable to support high current outflows. High current (both root mean square-rms and peak) equate with high energy consumption and accelerated wear or “aging” of drive train components. Stress on a hybrid-electric drive train would increase were such loads allowed. Battery management system strategy should provide a cell/module/pack voltage which allows for stable and repeatable operation.

Data quantifying such adverse system responses under some conditions allows a cost comparison to be made between the additional costs incurred by operation of the vehicle using its internal combustion (IC) engine 28 (See FIG. 2), mixing propulsion demand between electric motors 32 and the IC engine 28 or propelling the vehicle only from electric motor(s) 32, 30. It can also be used to determine how much regenerative braking to use to meet braking demand. One of the primary disadvantages of electric and hybrid-electric vehicles is the high cost of electric drive train compared to internal combustion engine equipped vehicles. Considering additional warranty cost of electric drive train, the cost disadvantage becomes an even bigger problem. Limiting the exercise of electrical components in a hybrid-electric drive train 20 under adverse conditions can extend the service lives of the components and reduce maintenance costs and vehicle down time by enough to pay for immediate savings in operating costs lost due to increased hydro-carbon fuel consumption.

FIG. 2 is a high level schematic of a control system 22 for a hybrid-electric drive train 20 which may be used with vehicle 102. Hybrid-electric drive train 20 illustrates the many possible examples of drive trains where rules of operation may be varied to meet propulsion and braking demand. Hybrid-electric drive train 20 is configurable for series, parallel and mixed series/parallel operation. Illustration of the methods disclosed here is not limited to a particular hybrid-electric system. Nor do hybrid vehicles necessarily combine IC engines and electric machines. IC engines can be replaced with external combustion engines. Another type of motor/pump which can operate with an RESS is a hydraulic motor. For a hybrid-hydraulic drive train a hydraulic accumulator serves as the RESS.

Hybrid-electric vehicles have generally been of one of two types, parallel and series. In parallel hybrid-electric systems propulsion torque can be supplied to drive wheels by an electrical motor, by a fuel burning engine, or a combination of both. In series type hybrid systems drive propulsion is directly provided only by the electrical motor. An internal combustion engine is used to run a generator which supplies electricity to power the electric traction motor and to charge storage batteries. In a series type system the control system may operate under a rule under which the internal combustion engine is started at a minimum threshold battery SOC, run at its most efficient brake specific fuel consumption output level until the battery reaches a maximum allowed SOC whereupon the IC engine is turned off.

Hybrid-electric drive train 20 includes an internal combustion (IC) engine 28 and two dual mode electrical machines 30, 32 which can be operated either as generators or motors. The dual mode electrical machines (motor/generator) 30, 32 can provide for vehicle propulsion. They can also generate electricity as a result either of regenerative braking of drive wheels 26 or by being directly driven by the IC 28 engine. In hybrid-electric drive train 20 the IC machine 28 can provide direct propulsion torque or can be operated in a series type hybrid-electric drive train configuration where it is limited to driving one or both of the electrical motor/generators 30, 32. Hybrid-electric drive train 20 also includes a planetary gear 60 for combining power output from the IC engine 28 with power output from the two electrical motor/generators 30, 32. A transmission 38 couples the planetary gear 60 with the drive wheels 26. Power can be transmitted in either direction through transmission 38 and planetary gear 60 between the propulsion sources and drive wheels 26. During braking planetary gear 60 can deliver torque from the drive wheels 26 to the motor/generators 30, 32 or, if the vehicle is equipped for engine braking, to engine 28, distribute torque between the motor/generators 30, 32 and IC engine 28.

A plurality of clutches 52, 54, 56 and 58 provide various options for configuring the electrical motor/generators 30, 32 and the engine 28 to propel the vehicle through application of torque to the drive wheels 26, to generate electricity by driving the electrical motor/generators 30, 32 from the engine, and to generate electricity from the electrical motor/generators 30, 32 by back driving them from the drive wheels 26. Electrical motor/generators 30, 32 may be run in traction motor mode to power drive wheels 26 or they may be back driven from drive wheels 26 to function as electrical generators when clutches 56 and 58 are engaged. Electrical motor/generator 32 may be run in traction motor mode or generator mode while coupled to drive wheels 26 by clutch 58, planetary gear 60 and transmission 38 while at the same time clutch 56 is disengaged allowing electrical motor/generator 30 to be back driven through clutch 54 from engine 28 to operate as a generator. Conversely clutch 56 may be disengaged and clutch 58 engaged and both motor/generators 30, 32 run in motor mode. In this configuration motor/generator 32 can propel the vehicle while motor/generator 32 is used to crank engine 28. Clutch 52 may be engaged to allow the use of IC engine 28 to propel the vehicle or to allow use of a diesel engine, if equipped with a “Jake brake,” to supplement vehicle braking. When clutches 52 and 54 are engaged and clutch 56 disengaged engine 28 can concurrently propel the vehicle and drive motor/generator 30 to generate electricity. Still further operational configurations are possible although not all are used. Elimination of some configurations can allow clutch 58 to be considered as “optional” and to be replaced with a permanent coupling.

The selective engagement or disengagement of clutches 52, 54, 56 and (if used) 58 allows hybrid-electric drive train 20 to be configured to operate in a “parallel” mode, in a “series” mode, or in a blended “series/parallel” mode. To configure drive train 20 for series mode operation clutches 54 and 58 could be engaged and clutches 52 and 56 disengaged. Propulsion power is then provided by motor/generator 32 and motor/generator 30 operates as a generator. To implement drive train 20 for parallel mode operation at least clutches 52 and 58 are engaged. Clutch 54 is disengaged. Motor/generator 32 and IC engine 28 are available to provide direct propulsion. Motor/generator 30 may be used for propulsion. A configuration of drive train 20 providing a mixed parallel/series mode has clutches 52, 54 and 58 engaged and clutch 56 disengaged. Motor/generator 32 operates as a motor to provide propulsion or in a regenerative mode to supplement braking IC engine 28 operates to provide propulsion and to drive motor/generator 30 as a generator.

Hybrid-electric drive train 20 draws on two reserves of energy, one for the electrical motor/generators 30, 32 and one for the IC engine 28. Electrical energy for the motor/generators 30, 32 is stored in an RESS which may take one of several forms such as capacitors but presently is more commonly constructed from traction batteries 34. Either storage system is subject to a maximum energy storage limit. Batteries 34 also exhibit rates of charging and discharging which may be limited in comparison to energy flow into or from a fuel tank 62 or capacitors. The availability of power from the electrical power reserve may be referred to as its state of energization (SOE) or, more usually with batteries, as its state of charge (SOC). In either case the value is indicated as a percentage. Combustible fuel for engine 28 is typically a hydro-carbon and, if liquid or gaseous, maybe stored in a fuel tank 62. The fuel tank 62 is resupplied from external sources and unlike the batteries 34 (which function as the vehicle's RESS) cannot be regenerated by operation of the vehicle.

Traction batteries 34 may be charged from external sources or by operation of the drive train 20. As already described, electrical motor/generators 30 and 32 may operate as generators to supply current to recharge traction batteries 34 over a high voltage energy bus 17 from the high voltage energy distribution sub-system. Hybrid power converter 36 provides voltage step down or step up and, if motor/generators 30, 32 are alternating current devices, current rectification and de-rectification between the motor/generators and batteries 34. Fuel, a form of stored energy, may be converted to electrical energy and thereby moved from the fuel tank 62 to the traction batteries 34. Traction batteries 34 may also be recharged through regenerative energy capture techniques such as regenerative braking, turbo compounding, regenerative energy capture through coastdown.

Control over drive train 20, the power converter 36 and traction batteries 34 is implemented by a control system 22. Control system 22 may be implemented using two controller area networks (CAN) based on a public data link 18 and a hybrid system data link 44. Control system 22 coordinates operation of the elements of the drive train 20 and the service brakes 40 in response to operator/driver commands to move (ACC/TP) and stop (BRAKE) the vehicle received through an electronic system controller (ESC) 24. Energy reserves in terms of the SOC of traction batteries 34 are managed taking into account the operator commands. The control system 22 selects how to respond to the operator commands to meet programmed objectives including efficiently maintaining the SOC of traction batteries 34 as well as protecting drive train 20 components.

In addition to the data links 18, 44, control system 22 includes the controllers which broadcast and receive data and instructions over the data links. Among these controllers is the ESC 24. ESC 24 is a type of body computer and is not assigned to a particular vehicle system. ESC 24 has various supervisory roles and is connected to receive directly or indirectly various operator/driver inputs/commands including brake pedal position (BRAKE), ignition switch position (IGN) and accelerator pedal/throttle position (ACC/TP). ESC 24, or sometime the engine controller 46, can also be used to collect other data such as ambient air temperature (TEMP). In response to these and other signals ESC 24 generates messages/commands which may be broadcast over data link 18 or data link 44 to an anti-lock brake system (ABS) controller 50, the transmission controller 42, the engine control unit (ECU) 46, hybrid controller 48 and a pair of accessory motor controllers 12, 14 and includes data transmission to and from a global positioning system unit 64 and a two way telematics unit 16.

Accessory motor controllers 12, 14 control for high voltage accessory motors 13, 15 in response to directions from other CAN nodes. High voltage accessory motors 13, 15 are direct current motors to support the operation of components such as an air conditioning compressor (not shown), a battery cooling loop pump (not shown) or a power steering pump (not shown). On many hybrid-electric vehicles there is no option to power such components directly from the internal combustion engine and the motors driving these components are parasitic loads on a motor/generator operating in generator mode or they draw power over a high voltage power distribution sub-system 19 from the traction batteries 34. Under conditions where a vehicle 102 is caught in slow moving traffic greater demands may be made on power steering. Under conditions of high heat and humidity greater demands are likely to be placed on air conditioning and for battery cooling. When these circumstances coincide the greatest stress due to heat is likely to be placed on the drive train 20 components particularly motor internal resistances rise and batteries 34 temperatures with increased frequency and depth and charging and discharging cycles.

Operator demand for power on drive train 20 power is a function of accelerator/throttle position (ACC/TP). ACC/TP is an input to the ESC 24 which passes the signal to the hybrid supervisory control module 48. Where engine 28 is supplying power both for propulsion and for charging of the traction batteries 34 an allocation of the available power from engine 28 is made by the hybrid supervisory control module 48.

Table I illustrates possible drive train 20 configurations related to traction batteries 34 SOC and vehicle operating conditions. The possible configurations are mixed series/parallel, parallel and series. The term “Regen Mode” refers to one of the motor/generators operating as a generator while being back driven from the drive wheels 26. A motor operating in a generator mode is driven by the engine 28. Clutch 58 is engaged for all examples. Propelling source, charging source and propel less charging source are listed in propel units. The table reflects a possible set rules for configuration of hybrid-electric drive train 20 to meet loads that may be imposed on the system.

TABLE I

| Comment | Light Load | Urgent SOC | Mid-Load | Max. Load | Heavy Load |
|---|---|---|---|---|---|
| Configuration | Series/Par | Series | Parallel | Parallel | Parallel |
| Propelling | Motor/Gen | Motor/Gen 32 | Both | Both Motor/ | Both |
| Source | 32 | | Motor/Gen | generators | Motor/generators, |
| | | | | Engine | Engine |
| Charging | Motor/Gen | Motor 32 in | Both motors in | Motor 32 in | Both motors in |
| Source | 32 in | Regen mode, | Regen mode | Regen mode, | Regen mode |
| | Regen | motor/gen 30 | | motor/gen 30 in | |
| | mode | in generator | | generator mode | |
| | | mode | | | |
| Clutch 52 | Disengaged | Disengaged | Disengaged | Disengaged | Engaged |
| Clutch 56 | Disengaged | Disengaged | Engaged | Engaged | Engaged |
| Clutch 54 | Disengaged | Engaged | Disengaged | Engaged | Disengaged |
| ACC/TP % | 20 | 50 | 50 | 80 | 60 |
| SOE/SOC % | 80 | 20 | 80 | 50 | 70 |
| Propelling S. | 150 | 150 | 300 | 471 | 471 |
| Charging S | 15 | 165 | 30 | 165 | 30 |
| Propel less | 135 | −15 | 270 | 306 | 441 |
| charging | | | | | |

Maintaining batteries 34 SOC is subject to various constraints including the present SOC of the traction batteries 34 and a dynamic limit on the rate at which the traction batteries 34 can accept charge. The traction batteries 34 and engine 28 can be selected so that the engine can be run at its most efficient brake specific fuel consumption during pure charging operation up to a nominal SOC, usually 80% of a full charge. Thus the dynamic limit on the rate of charge can be disregarded during periods when both charging and propulsion are demanded from the drive train 20. The hybrid controller 48 monitors batteries 34 SOC and when charging of batteries 34 is indicated allocates available torque from the engine 28 or from the drive wheels 26 during dynamic regenerative braking to motor/generators 30 and/or 32 to generate electricity for charging traction batteries 34.

Consideration of modification of the operational rules for a control algorithm based on traffic, road and weather conditions can now be considered. Any control algorithm includes a number of definitions.

RESS (Rechargeable Energy Storage System) Management System: For a typical hybrid-electric vehicle this is known as a battery management system (BMS). This component monitors the state of the battery in terms of useable energy, power capability, health, voltage and temperature.

RESS State of Health: A quantitative measure of the health of the RESS. Avoiding declines in the State of Health of the RESS is a factor guiding rule selection and/or parameter value selection.

RESS State of Charge and State of Energy: Quantitative measures of the amount of useful energy contained in the RESS.

Expected RESS Load for the Next Driving Period how the battery will be used in the near future. This is derived from weather, road condition and traffic data as well as the vehicle load. For example, the frequency of stops may be projected from traffic conditions and GIS information about the projected route of the vehicle.

Preferred charge rate for RESS life, charger life, temperature distribution: The vehicle system, especially the HEV components, has designated operational limits. These limits are in place to preserve the performance level and reliability/durability of the components. For example the battery cells have a charge-rate limit to preserve the battery's useful lifetime. These rates can vary with operating temperature.

Determination of maximum allowed RESS load for a particular class of vehicle and particular hybrid-electric drive train can be developed from long term operational histories and stored on data bases 128 or locally on the vehicle. Such values are subject to being updated over time and for upgrades or changes in drive train components.

Knowledge of likely vehicle speed and probability of variation in speed, along with changes in parasitic demand and losses stemming from weather conditions allows for power demand and opportunities for regenerative braking to be projected. A target or maximum allowed RESS Load may be provided and operational rules may be varied in an attempt to reduce Expected RESS Load to this maximum allowed level, or at least to minimize occasions of exceeding it. Alternatively, short term and long term maximum allowed RESS load can be provided. Transients above a long term limit may be allowed but limited in duration and frequency. IC engine 28 operation may be expanded as called for to reduce Expected RESS Load in any drive train 20 configuration. Service brake 40 operation or IC engine 28 braking (if not disallowed by local ordinance) may be substituted for regenerative braking to avoid over heating and/or stress on the batteries 34. Loss of opportunities for regenerative braking may be used to force greater IC engine 28 operation at a base output level to meet high voltage accessory motor demand plus a varying output level to support propulsion demand and thereby minimize current flow into and out of the batteries 34. For drive train 20, because it can be reconfigured between serial, parallel and mixed serial/parallel operation it is possible to specify changes in configuration not withstanding a rule which would usually entail operation in a particular configuration. This could be done to allow increased reliance on IC engine 28. Analogous values may be developed for other components in drive train 20 which may be subject to heat accelerated aging, such as the motor/generators 30, 32 or the hybrid power converter 36.

What is claimed is:

1. A vehicle comprising:
a rechargeable energy storage system;
a motor adapted to draw energy from the rechargeable energy storage system to provide propulsion for the vehicle;
means for charging the rechargeable energy storage system;
an engine connectable for driving the means for charging and to provide propulsion for the vehicle;
an operator input for requesting propulsion;
a control system responsive to requests for propulsion for engaging the engine, the traction motor, or both to meet the requests for propulsion and for generating an allocation of what proportion of the request is met by the motor and by the engine;
a source of data relating to conditions in a region where the hybrid vehicle is operating allowing generation of a projection of operational expectations for the hybrid vehicle; and
the control system being responsive to the projection for adjusting the allocation.

2. The vehicle of claim 1, wherein:
the rechargeable energy storage system comprises electrical storage batteries; and
the motor is a dual mode electrical motor/generator.

3. The vehicle of claim 2, further comprising:
means responsive to a request for braking for back driving the electrical motor/generator from vehicle drive wheels to generate electricity for recharging the electrical storage batteries; and
the control system being responsive to the projection for allocating requests for braking between service brakes and back driving the electrical motor/generator.

4. The vehicle of claim 3, further comprising:
the conditions in a region including a definition of the region and data relating weather, traffic and road conditions.

5. The vehicle of claim 4, further comprising:
drive train component stress limits characterized in terms of weather and expected component loading.

6. A method of operating a vehicle having a drive train comprising at least a first configuration of an electrical motor for propulsion, an internal combustion engine, a source of generated electricity and a rechargeable energy storage system, the method comprising the steps of:
obtaining data relating to expected conditions of operation including one or more of the following, weather, traffic and road conditions;
generating requests for propulsion;
responsive to requests for propulsion determining what proportion of the request for propulsion to allocate to the internal combustion engine and what proportion to allocate to the electrical motor wherein the proportion of the request for propulsion allocated to the internal combustion engine is increased in favor of the internal combustion engine to prevent operation of the vehicle under expected conditions of operational stress on components of a vehicle drive train including the electrical motor beyond a predetermined limit.

7. The method of claim 7, further comprising a step of:
responsive to a request for braking allocating braking effort between service brakes and regenerative braking using the electrical motor as a generator to charge the rechargeable energy storage system, with allocation of braking effort to the service brakes being an increasing function of expected conditions of operational stress on the components of the vehicle drive train.

8. A vehicle comprising:
a rechargeable energy storage system;
a drive train comprising at least a first configuration of a motor for propulsion, an internal combustion engine for propulsion and means for charging the rechargeable energy storage system where the means for charging can be driven by the internal combustion engine or from drive wheels;
means for obtaining data relating to expected conditions of operation of the hybrid vehicle including data relating to at least one more of the following types, weather, traffic conditions and road conditions;
means for generating requests for propulsion; and
means responsive to requests for propulsion for determining what proportion of the request for propulsion to allocate to the internal combustion engine and what proportion to allocate to the motor wherein the proportion of the request for propulsion allocated to the internal combustion engine is increased in favor of the internal combustion engine to prevent operation of the vehicle under expected conditions of operational stress on components of the drive train including the motor beyond a predetermined limit.

9. The vehicle of claim 8, further comprising:
service brakes;
means for generating braking requests;
means responsive to a request for braking allocating braking effort between the service brakes and regenerative braking using the means for charging to charge the rechargeable energy storage system, with allocation of braking effort to the service brakes based on avoiding imposition of stress on means for charging and the rechargeable energy storage system beyond a predetermined limit.
